(19) United States
(12) Patent Application Publication
(10) Pub. No.: US 2016/0342161 A1
(43) Pub. Date: Nov. 24, 2016

(54) Tank Filling, Monitoring and Control System

(71) Applicant: Crescent Services, L.L.C., Oklahoma City, OK (US)

(72) Inventors: Stephen Allen, Oklahoma City, OK (US); Michael Fontaine, Oklahoma City, OK (US); Joseph Allen Thomas, Round Rock, TX (US)

(21) Appl. No.: 14/720,440

(22) Filed: May 22, 2015

(51) Int. Cl. G05D 9/12

(52) U.S. Cl. CPC G05D 9/12

(57) ABSTRACT

A system and method for regulating the amount of water in a battery of storage tanks for use in hydraulic fracturing. The system includes a source for the water, attached to the battery of tanks using pumps and controllable valves. Levels in the tanks are transmitted to a central processing unit, which controls the valves to govern the flow of water. Remote monitoring and control is enabled by communication between the central processing unit and a monitoring location.

### CROSS REFERENCE TO RELATED APPLICATIONS

This application claims the benefit of U.S. Provisional Application Ser. No. 62/001,770 entitled TANK FILLING, MONITORING AND CONTROL SYSTEM, filed May 22, 2014.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention relates generally to the filling and emptying of liquid to and from multiple tanks, and more particularly to an automated control system and method that governs the filling and emptying of liquid to and from multiple holding tanks for use in hydraulic fracturing.

Hydraulic fracturing is a process used in oil field applications to stimulate the production of hydrocarbons from a well. Large volumes of water, along with substances such as sand and chemicals, are pumped into a well. Sufficient amounts of water, typically stored in tanks, must be available at the well site to successfully fracture the well. During a hydraulic fracturing job, the tanks are filled from one or more water sources and in turn the water from the tanks is pumped into the well using high capacity pumps. The level of water in the tanks and pumps supplying the water must be monitored to insure that a sufficient volume of water is available to properly complete the job. Additionally, it is beneficial to monitor certain characteristics of the water to insure a particular composition and amount of water is available to be pumped into the well.

### BRIEF SUMMARY OF THE INVENTION

The present invention is directed to a method of maintaining a desired level of liquid in a tank. The tank has an input valve and an output. The steps of the method comprise providing a source of the liquid and coupling the source to the tank using the input valve. The input valve is controllable from a central processing unit. The steps further comprise connecting the output to an output valve so that liquid can exit through the output. The level of the liquid in the tank is then measured and the measured level is transmitted to the central processing unit. The input valve is controlled to govern the amount of liquid that enters the tank. The input valve can be adjusted by entering a preferred level at the central processing unit or at a remote monitor that is in communication with the central processing unit.

The present invention is also directed to a system for regulating the amount of liquid in a plurality of tanks that have an input valve. The input valve is controllable from a central processing unit. The system includes a source of the liquid connected to a manifold, wherein the manifold is connected to the input valves. A sensor in the tanks measures the amount of the liquid in the tanks and is in communication with the central processing unit that receives measurements from the sensors. The amount of liquid in the tanks is regulated by commands sent from the central processing unit to the input valves, increasing the flow of the liquid into the tanks when the amount of liquid is below a desired level and decreasing the flow of the liquid when the amount of the liquid is above a desired level.

### BRIEF DESCRIPTION OF THE DRAWINGS

FIG. 1 is a schematic view of a tank filling, monitoring and control system in accordance with the present invention.

FIG. 2 is a schematic view of portion of the tank filling, monitoring and control system shown in FIG. 1 in accordance with the present invention.

FIG. 3 is a schematic view of a supervisor unit of a tank filling, monitoring, and control system in accordance with the present invention.

FIG. 4 is a schematic view of a master communication unit of a tank filling, monitoring, and control system in accordance with the present invention.

FIG. 5 is a schematic view of an input/output (I/O) unit of a tank filling, monitoring, and control system in accordance with the present invention.

FIG. 6 is a schematic view of an alternate embodiment of a tank filling, monitoring, and control system in accordance with the present invention.

### DETAILED DESCRIPTION OF THE INVENTION

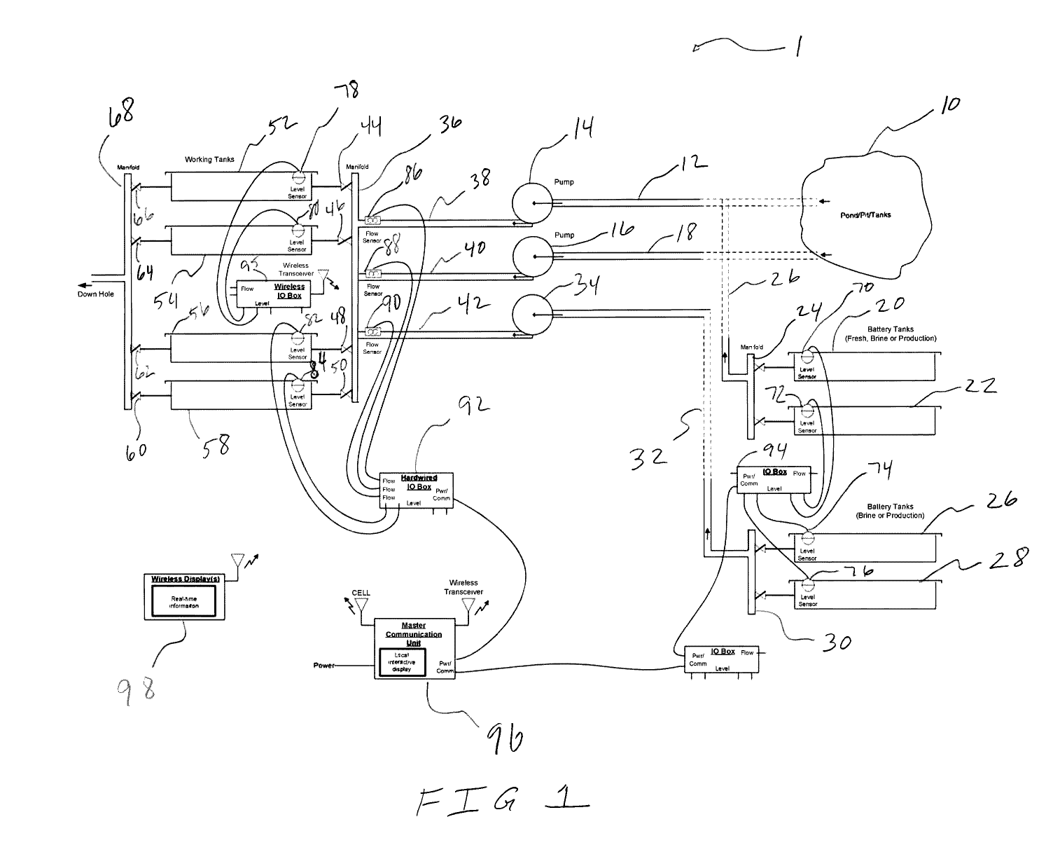

Referring now to the drawings, and more particularly to FIG. 1, various aspects of a tank filling and monitoring system 1 is illustrated. A pond, pit, tanks or other water source 10 is required to provide fresh water, brine water or produced water, for a hydraulic fracturing job. Pipe 12 is placed at the water source and pump 14 is used to pump water from the water source 10. Pipe 12 is preferably polyurethane, rubber nitrile or aluminum. It should be known that for some distances it is helpful to use multiple pumps 14 on a single run of pipe 12 to provide extra pumping capacity for the water as shown in FIG. 6. Referring again to FIG. 1, an additional pump 16 can also be used with additional runs of pipe 18 to provide extra pumping capacity from the water source. In some cases it may be desirable to use one or more tanks 20, 22 to supplement or replace the water source 10 as local conditions often dictate the need for other water sources. Alternatively, tanks 20, 22 can be tank trucks or a combination of tanks and tank trucks. In this case the tanks 20, 22 are typically connected to a manifold 24 in a manner that is well known in the industry. The manifold 24 is then connected to the pump 14 via pipe 26. It should be known that in some cases pumps will not be needed because gravity can be used to move water to fill the tanks However, for illustration purposes, the use of pumps is included herein and most aspects of the invention can be used with or without pumps.

The oil and gas industry also makes use of produced water for hydraulic fracturing. One or more tanks 26, 28 are used to store the produced water and, similar to the fresh water tanks 20, 22, tanks 26, 28 can be connected to a manifold 30. The manifold 30 is then connected to pipe 32, which is in turn connected to pump 34. As in the process of pumping fresh water, multiple pumps 34 can be connected along pipe 32 to increase the pumping power as required. Multiple pipes and pumps (not shown) can also be used to increase the capacity of produced water from the tanks 26, 28. In some cases, pumps 14, 16, 34 can be omitted if sufficient elevation changes are present to allow for the water to flow from gravity.

Water from pump 14 then flows to manifold 36 through pipe 38 and, if utilized, from pump 16 through pipe 40 and from pump 34 through pipe 42. It should be known that multiple pumps will not always be used but additional pumps can be used to increase the capacity of the system of the present invention. Water in the manifold 36 then exits through valves 44, 46, 48, 50 into working tanks 52, 54, 56, 58. It should be known that the number of valves, pipes, manifolds and working tanks in FIG. 1 is for illustration purposes and can be increased or decreased as needed to supply the required amount of water for the hydraulic fracturing job.

The water in the working tanks 52, 54, 56, 58 then exits through valves 60, 62, 64, 66 into manifold 68. After the water exits the manifold 68, it then enters equipment (not shown) designed for hydraulic fracturing, typically very high capacity pumps and hardware in a manner that is well known in the art.

During an operation to fill the working tanks 52, 54, 56, 58 it is desirable to measure certain characteristics of the system. For example, level sensors 70, 72 in fresh water tanks 20, 22 measure the amount of water. In a presently preferred embodiment, fresh water levels are computed using sensors that reside on the bottom of the tanks and measure the pressure of the water in the tanks This method of measurement is accurate due to the relatively consistent and generally harmless properties of fresh water. Conversely, level sensors 74, 76 measure the amount of water in the produced water tanks 26, 28. Because produced water may be corrosive and is somewhat inconsistent in its composition, level sensors 74, 76 are preferably mounted above the level of the water in tanks 26, 28 and the produced water levels are computed from the height of the produced water. In a presently preferred embodiment, the sensors 74, 76 are ultrasonic and thus employ high frequency sound waves to measure the height of the produced water in tanks 26, 28. The height is then used to compute the volume of water taking into consideration the various geometries of tanks. In an alternate preferred embodiment, a single sensor 74 may be used for one tank in conjunction with sensors 70 and 72 installed in the tanks The variance in level readings between sensors 74 and 70 is used to compute an adjusted height in liquid that is then propagated to all tanks that have the same type of liquid. This provides an accurate level reading for all tanks that sensors 70 and 72 are installed. In an alternate preferred embodiment, sensors 74, 76 use radar to find the height of the water in the tanks 26, 28. Similarly, level sensors 78, 80, 82, 84 are also employed in the working tanks 52, 54, 56, 58. These sensors can also be ultrasonic or any other sensors capable of providing a digital or analog value that is representative of the level of water.

Flow sensors 86, 88, 90 are capable of providing an electronic signal representing the flow through pipes 38, 40, 42 are preferably used to measure the flow rate of water in pipes 38, 40, 42. Additional flow sensors can be placed throughout the system, for example in pipes 12, 18, 26, 32 (sensors not shown). These sensors allow the operator to monitor the flow rates and total volume of water that is flowing or has flowed in the system. Similarly, pressure sensors (not shown) can be placed before and after the pumps and in some cases to detect breaks or leaks.

Additional sensors can be used in the system such as fuel sensors at the pumps, pH sensors in the tanks, temperature sensors in the tanks, chloride sensors in the tanks, total dissolved solids (TDS) sensors in the tanks, and specific gravity sensors in the tanks Because the composition of water for hydraulic fracturing is important for a particular fracturing job, the characteristics of the water measured by the sensors can have an impact on the job.

Data from the sensors is preferably collected at a central point. In a presently preferred embodiment, IO box 92 is affixed by magnet or other method to one of working tanks 52, 54, 56, 58. Level sensors 78, 80, 82, 84 and flow sensors 86, 88, 90 are preferably hard wired to IO box 92. Depending on the capacity of the IO box, additional boxes can be added for jobs that require more sensors than can be connected to a particular IO box. For example, if an IO box has the capability for 100 sensors, additional IO boxes can be added in systems that exceed that amount. IO box 94 is preferably affixed by magnet or other method to one of tanks 20, 22, 26, 28. Likewise, sensors 70, 72, 74, 76 are preferably hardwired to IO box 94, with additional IO boxes to be utilized if needed for input capacity. As an illustration, IO box 95 is hardwired to sensors 78, 80. IO Box 95 can then be used to transmit the information either by hardwire or over the air, as described below.

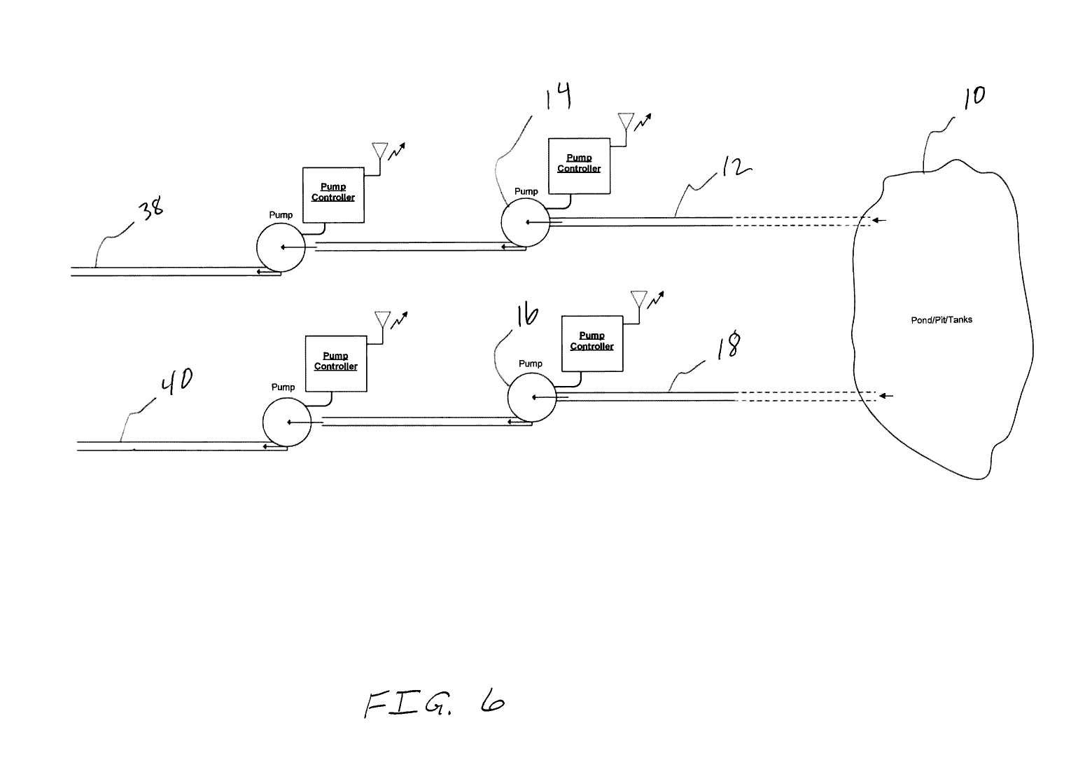

IO boxes 92, 94, 95 (an exemplary IO box is shown in FIG. 5) can be hard wired to master communication unit 96, which is also affixed to one of the working tanks on location, typically by magnet. Alternatively, any number of the IO boxes, level sensors or flow sensors in the system can communicate with the master communication unit 96 by wireless means. Other hardware may be required to complete this wiring, but in effect the wiring creates a communicable path from the sensors to the master communication unit 96. In a presently preferred embodiment, the master communication unit has the capacity to communicate with over 200 IO units.

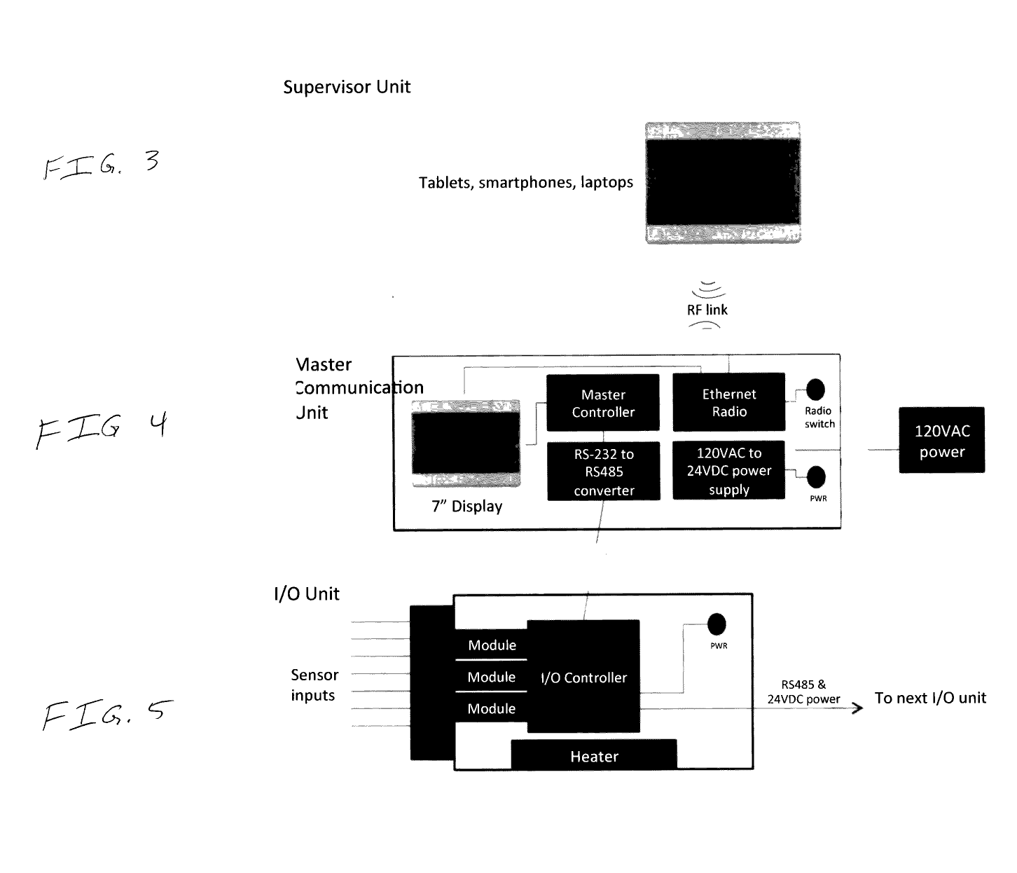

The master communication unit 96 includes means by which it can communicate with other sensors in the system that are not wired directly, as well as with the pumps and valves in the system. The communication means can be by radio, cell technology, Ethernet, or other non-wired means of communication. The master communication unit 96 also includes means to communicate with supervisor box 98 (shown in FIG. 3), preferably by radio, cell technology, Ethernet, or other non-wired means of communication. In a presently preferred embodiment, master communication unit 96 (shown in FIG. 4) also includes a central processing unit to control aspects of the system in response to readings from sensors in the system and to control equipment in the system such as pumps and valves.

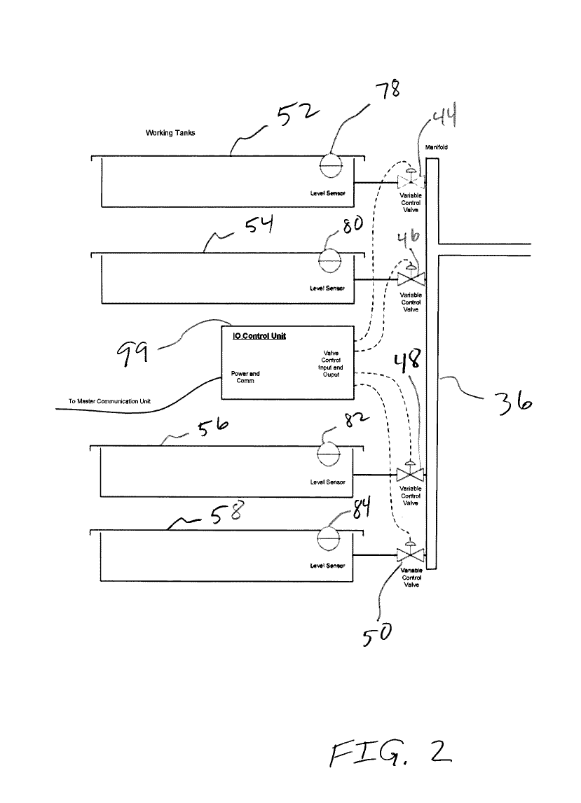

Referring now to FIG. 2, shown therein is a diagram of an IO box 99. The IO box 99 allows for automatic control of the valves 44, 46, 48, 50 using wired or wireless means and is connected to the master communication unit 96, via wired or wireless means.

Referring again to FIG. 1, the method and apparatus for filling the working tanks 52, 54, 56, 58 begins at the water source 10, that can be a naturally occurring pond, river, lake, other body of water, artificial pit, containment area or tank. Depending on the water requirement, a singular pipe 12 or multiple pipes are placed from the water source 10. As is known in the industry, multiple pumps can be placed along the pipe 12, as distances from the water source to a well site are often many miles (See FIG. 6, for example). Pressure sensors are also preferably used in the pipe 12 near the water source 10. In an alternate preferred embodiment, pressure sensors are also used in the pipe 12, 18, 32 before the pump 14, 16, 34 and in the pipe 38, 40, 42. In the cases when additional pumps are added to a pipe, pressure sensors can also be used in close proximity to the additional pumps as well. The pump pressure measurements are transmitted to the master communication unit 96 or IO box 92 and ultimately to the supervisor box 98 to permit monitoring of these readings and automatic or supervisory control of the system. All measurements in the system are preferably transmitted to a remote location to permit remote monitoring and control, such as by Internet, cell or other communication means.

As the pump (or series of pumps) moves water through pipes 38, 40, 42 and to manifold 36, the water passes through flow sensors 86, 88, 90. Flow information is transmitted, by hard wire connection or wirelessly, to master communication unit 96, to supervisor box 98 and to any remote monitoring location (not shown). It is well known that flow from the manifold 36 into working tanks 52, 54, 56, 58 will result in uneven filling of these tanks Because evenly filling the tanks 52, 54, 56, 58 is desired, a presently preferred embodiment is to automatically control valves 44, 46, 48, 50 to cause the tanks to fill evenly. This is made possible by a control system that determines the level of water in the tank from level sensors 78, 80, 82, 84 and increases or decreases the flow through the valves accordingly based on computations of the central processing unit in the master communication unit 96. Each control valve is operated automatically by the master communication unit 96 by producing separate signals for each control valve 44, 46, 48 and 50. These signals cause the valves to open more or close more based on the current valve position of each valve 44, 46, 48, and 50. Similar control of the speed of the pumps 14, 16, 34 can be varied by the system as needed to increase or decrease the flow of water in 1 or more of the pipes leading to the tanks 52, 54, 56, 58 (see FIG. 6, for example). This control can be done remotely from a phone, computer or anywhere else that has communication with the system. The control consists of setpoints for desired line pressure or flow rate for each specific pump 14, 16 and 34. In an alternate preferred embodiment, pumps 14, 16 and 34 can be automatically controlled to provide a desired mixture of liquids into manifold 36. The desired mixture can be changed at any time during the execution of setting up or performing a fracking operation.

When the working tanks 52, 54, 56, 58 are filled to a desirable level, the hydraulic fracturing operation can commence. The fracturing operation usually takes place in stages, as is well known in the industry, so the working tanks may undergo the filling process more than once during an operation. Those controlling the fracturing operation, referred to herein as the Operator, typically control the operation from a mobile control module referred to as a data van or a frac van. An HDMI or other high quality monitor that displays data from the tank filling and monitoring system 1 is preferably placed in the frac van so that the hydraulic fracturing operation can be controlled in accordance with data from the tank filling and monitoring system 1. The information sent to the monitor in the frac van is preferably sent over the air via WIFI, radio or cell phone signal. When the water reaches the manifold 68 it enters the hydraulic fracturing equipment for use down hole.

In a presently preferred embodiment, the function of the supervisor box 98 is accomplished by use of a tablet computer. Although interaction with the system 1 is preferred in this fashion, it will be known that many options exist for viewing data and entering commands to the system 1 using other types of computing devices. It is desirable that information available at the supervisor box 98 includes flow rates, tank levels, barrels of water remaining in the tank, etc.

The system 1 also takes on a reporting function so that additional parameters of the water in the system 1 are sent to the Operator, preferably in the frac van. Information such as water levels in the working tanks, water use for each stage, down hole pumping rates, time until all tanks are at a defined level based on current rates, composition of water such as pH, TDS, temperature, conductivity and specific gravity. All measurements in the system can also be transmitted to the Internet so that near real time data can be viewed anywhere. Information can also be transmitted by cell phone data, text message, email, etc. The system allows alarms to be set such that certain high or low water levels in the tanks automatically notify the users of levels. Alarms for other conditions that can be measured in the system are also used to notify observers of the system via email, text, and or voice.

What is claimed is:

1. A method of maintaining a desired level of liquid in a tank having an input valve and an output; comprising the steps of:
providing a source of the liquid and coupling the source to the tank using the input valve controllable from a central processing unit;
connecting the output to an output valve so that liquid can exit through the output;
measuring the level of the liquid in the tank;
transmitting the measured level to the central processing unit; and
controlling the input valve to govern the amount of liquid that enters the tank, wherein the input valve can be adjusted by entering a preferred level at the central processing unit or at a remote monitor that is in communication with the central processing unit.

2. The method of claim 1, wherein the level of the liquid is maintained in a plurality of tanks, each tank having an input valve and an output.

3. The method of claim 1, wherein one or more pumps are coupled between the source and the input valve.

4. The method of claim 1, wherein the liquid is a mixture from a plurality of sources.

5. The method of claim 4, wherein sensors in the source tanks communicate the level of liquid in the source tanks to the central processing unit.

6. The method of claim 4, wherein sensors in the tank measure characteristics of the liquid in the tank and transmit the measured characteristics to the central processing unit.

7. The method of claim 6, wherein the central processing unit changes the characteristics by adjusting the flow of liquid from the sources.

8. The method of claim 2, wherein one or more additional sensors from the set of a pH sensor in the tanks, a chloride sensor in the tanks, a total dissolved solids sensor in the tanks, a conductivity sensor in the tanks, a specific gravity sensor in the tanks, a fuel sensor at a pump that is connected between the source and the manifold, and a flow sensor that is connected between the source and the input valve, each sensor in communication with the central processing unit.

9. The method of claim 8, wherein the central processing unit changes the characteristics by adjusting the flow of liquid from the sources.

10. A system for regulating the amount of liquid in a plurality of tanks that have an input valve controllable from a central processing unit, comprising:
a source of the liquid connected to a manifold, wherein the manifold is connected to the input valves;
a sensor in the tanks that measures the amount of the liquid in the tanks, the sensor in communication with the central processing unit that receives measurements from the sensors;
wherein the amount of liquid in the tanks is regulated by commands sent from the central processing unit to the input valves, increasing the flow of the liquid into the tanks when the amount of liquid is below a desired level and decreasing the flow of the liquid when the amount of the liquid is above a desired level.

11. The system of claim 10, comprising a monitor in communication with the central processing unit that receives data measurements from the system and sends commands to the central processing unit.

12. The system of claim 11, wherein the source is a fresh water reservoir and a second source is a produced water reservoir.

13. The system of claim 12, comprising a source level sensor at the fresh water reservoir and a second source level sensor at the produced water reservoir, each in communication with the central processing unit.

14. The system of claim 11, wherein the liquid is used for hydraulic fracturing of a well to produce hydrocarbons.

15. The system of claim 14, wherein the central processing unit is connected to the Internet, sends the data measurements to a computer connected to the Internet, and receives commands from the computer to regulate the amount of liquid in the tanks.

16. The system of claim 11, comprising one or more additional sensors from the set of a pH sensor in the tanks, chloride sensor in the tanks, total dissolved solids sensor in the tanks, a conductivity sensor in the tanks, specific gravity sensor in the tanks, a fuel sensor at a pump that is connected between the source and the manifold, and a flow sensor that is connected between the source and the manifold, each sensor in communication with the central processing unit.

17. A system for providing a desired amount of liquid for hydraulic fracturing, comprising:
a source of the liquid;
liquid storage tanks;
a means for moving the liquid from the source to the tanks; and
a means for regulating the amount of liquid in the tanks
